(19) United States
(12) Patent Application Publication
(10) Pub. No.: US 2026/0327454 A1
(43) Pub. Date: Oct. 22, 2026

(54) POLYAMIC ACID, POLYAMIC ACID COMPOSITION, POLYIMIDE, POLYIMIDE FILM, LAMINATE, METHOD OF PRODUCING LAMINATE, AND ELECTRONIC DEVICE

(71) Applicant: KANEKA CORPORATION, Osaka (JP)

(72) Inventors: Hirofumi Nakayama, Otsu-shi (JP); Nobuaki Tanaka, Otsu-shi (JP)

(73) Assignee: KANEKA CORPORATION, Osaka (JP)

(21) Appl. No.: 19/672,652

(22) Filed: May 10, 2026

Related U.S. Application Data
(63) Continuation of application No. PCT/JP2024/031540, filed on Sep. 3, 2024.

(30) Foreign Application Priority Data
Nov. 10, 2023 (JP) 2023-192434
Aug. 7, 2024 (JP) 2024-131060

(51) Int. Cl. C09D 179/08; C08G 73/10

(52) U.S. Cl. CPC C09D 179/08; C08G 73/1042; C08G 73/1067

(57) ABSTRACT

The polyamic acid includes a tetracarboxylic dianhydride residue and a diamine residue. The diamine residue includes a divalent organic group represented by General Formula (1). The tetracarboxylic dianhydride residue includes one or more residues selected from the group consisting of a tetravalent organic group represented by Chemical Formula (2), a tetravalent organic group represented by Chemical Formula (3), a tetravalent organic group represented by Chemical Formula (4), a tetravalent organic group represented by Chemical Formula (5), a tetravalent organic group represented by Chemical Formula (6), a tetravalent organic group represented by Chemical Formula (7), a tetravalent organic group represented by Chemical Formula (8), a tetravalent organic group represented by Chemical Formula (9), and a tetravalent organic group represented by Chemical Formula (10).

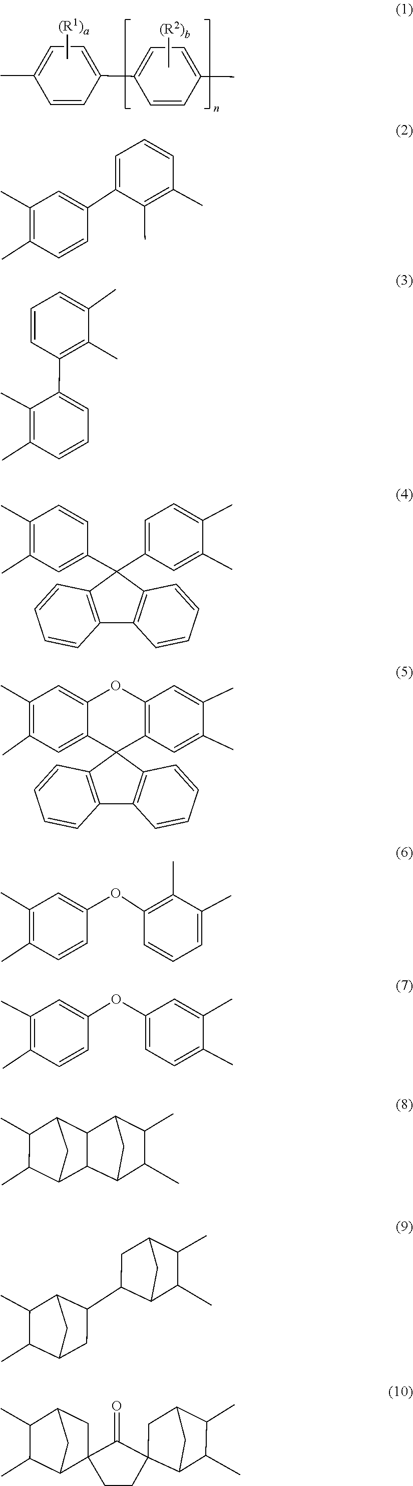

### TECHNICAL FIELD

One or more embodiments of the present invention relate to a polyamic acid, a polyamic acid composition, a polyimide, a polyimide film, a laminate, a method of producing a laminate, and an electronic device. One or more embodiments of the present invention further relate to an electronic device material in which a polyimide is used, a thin film transistor (TFT) substrate, a flexible display substrate, a color filter, a printed matter, an optical material, an image display device (more specifically, a liquid crystal display device, an organic EL, an electronic paper, or the like), a 3D display, a solar cell, a touch panel, a transparent conductive film substrate, and an alternative material for a member in which glass is currently used.

### BACKGROUND

With rapid progress of displays such as liquid crystal displays, organic electroluminescence (organic ELs), and electronic papers and electronic devices such as solar cells and touch panels, devices have been progressively made thinner, lighter, and more flexible. In these devices, a polyimide is used as a substrate material instead of a glass substrate.

In these devices, various electronic elements such as a thin film transistor and a transparent electrode are formed on a substrate, and formation of these electronic elements needs a high-temperature process. A polyimide has heat resistance sufficient to be adaptable to a high-temperature process, and has a thermal expansion coefficient (CTE) close to that of a glass substrate or an electronic element, so that internal stress is less likely to occur. Thus, a polyimide is suitable for a substrate material for a flexible display and the like.

An aromatic polyimide is generally yellowish-brown color due to intramolecular conjugation or formation of a charge transfer (CT) complex. In top-emission type organic ELs and the like, light is extracted from the opposite side of a substrate, and therefore the substrate is not required to have transparency, and a conventional aromatic polyimide has been used. However, in a case where light emitted from a display element is emitted through a substrate as in a transparent display, a bottom-emission type organic EL, or a liquid crystal display, or in a case where a sensor or a camera module is disposed on the back surface of a substrate in order to make a smartphone or the like a full-surface display (notchless), the substrate is also required to have high optical properties (more specifically, transparency and the like).

From such a background, there is a demand for a material that has heat resistance equivalent to that of an existing aromatic polyimide and is less colored and excellent in transparency.

Techniques of suppressing formation of a CT complex using an aliphatic monomer (Patent Documents 1 and 2) and a technique of enhancing transparency by using a monomer having a fluorine atom (Patent Document 3) are known as techniques for reducing coloring of a polyimide.

The polyimides described in Patent Documents 1 and 2 have high transparency and a low CTE, but have a low thermal decomposition temperature because an aliphatic structure is included, and therefore these polyimides are difficult to apply to a high-temperature process at the time of forming an electronic element.

### PATENT DOCUMENTS

Patent Document 1: JP 2016-29177 A
Patent Document 2: JP 2012-41530 A
Patent Document 3: JP 2014-70139 A

The polyimide described in Patent Document 3 is excellent in transparency, but as a result of studies of the present inventors, it has been found that hydrogen fluoride may be generated in a high-temperature process because the polyimide includes a fluorine atom. Generation of hydrogen fluoride may cause adhesion failure between the polyimide and a barrier film or the like, or may cause corrosion of an electronic element provided on the polyimide film.

### SUMMARY

One or more embodiments of the present invention have been made in view of the above, and a polyimide excellent in transparency and capable of suppressing generation of hydrogen fluoride during a high-temperature process, and a polyamic acid as a precursor of the polyimide are provided. Furthermore, a product or a member that is produced using the polyimide and the polyamic acid and is required to have transparency is provided.

One or more embodiments of the present invention are as follows.
[1]A polyamic acid including a tetracarboxylic dianhydride residue and a diamine residue,
the diamine residue including a divalent organic group represented by General Formula (1) described below, and
the tetracarboxylic dianhydride residue including one or more selected from the group consisting of a tetravalent organic group represented by Chemical Formula (2) described below, a tetravalent organic group represented by Chemical Formula (3) described below, a tetravalent organic group represented by Chemical Formula (4) described below, a tetravalent organic group represented by Chemical Formula (5) described below, a tetravalent organic group represented by Chemical Formula (6) described below, a tetravalent organic group represented by Chemical Formula (7) described below, a tetravalent organic group represented by Chemical Formula (8) described below, a tetravalent organic group represented by Chemical Formula (9) described below, and a tetravalent organic group represented by Chemical Formula (10) described below:

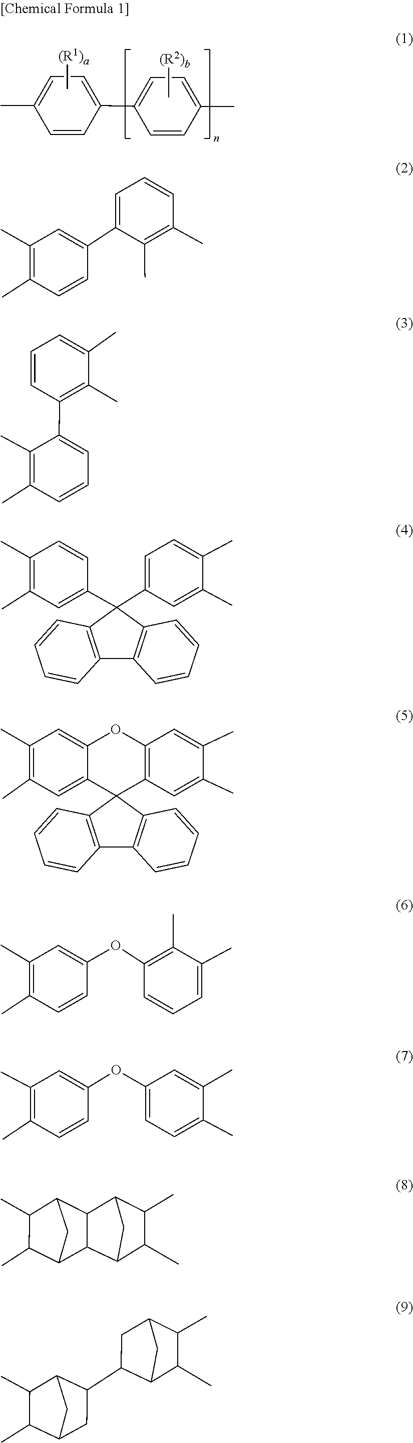

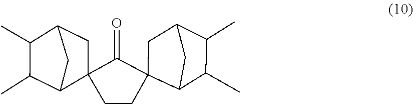

in which R¹ and R² each independently represent a trifluoromethoxy group, a pentafluoroethoxy group, or a heptafluoropropoxy group, a represents an integer of 1 or more and 4 or less, b represents an integer of 0 or more and 4 or less, a plurality of R¹s are optionally equal to or different from each other in a case where a represents an integer of 2 or more and 4 or less, a plurality of R²s are optionally equal to or different from each other in a case where b represents an integer of 2 or more and 4 or less, and n represents an integer of 0 or more and 3 or less.
[2] The polyamic acid according to [1], in which the tetracarboxylic dianhydride residue further includes one or more selected from the group consisting of a tetravalent organic group represented by Chemical Formula (11) described below, a tetravalent organic group represented by Chemical Formula (12) described below, and a tetravalent organic group represented by Chemical Formula (13) described below.

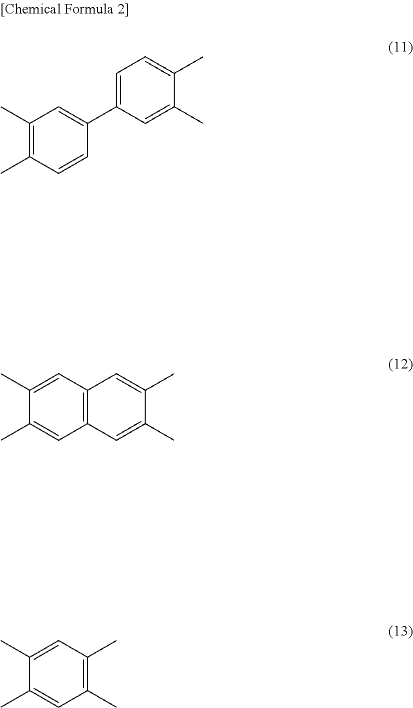

[3]A polyamic acid composition including the polyamic acid according to [1] or [2] and an organic solvent.
[4] The polyamic acid composition according to [3], further including one or more compounds selected from the group consisting of tertiary amines, phosphorus-containing compounds, and phenolic compounds.
[5] The polyamic acid composition according to [4], in which an amount of the one or more compounds selected from the group consisting of tertiary amines, phosphorus-containing compounds, and phenolic compounds is 0.001 parts by weight or more and 20 parts by weight or less with respect to 100 parts by weight of the polyamic acid.
[6]A polyimide being an imidized product of the polyamic acid according to [1] or [2].
[7] The polyimide according to [6], in which in a mass spectrum obtained by heating the polyimide at a temperature rise rate of 10 °C/min from an atmospheric temperature of 60 °C to 500 °C under a helium gas flow and analyzing a gas generated from the polyimide with a quadrupole mass spectrometer, a value obtained by dividing a detection intensity of a peak at m/z=20 at an atmospheric temperature of 450 °C by a detection intensity of a peak at m/z=20 at an atmospheric temperature of 100 °C is 3.0 or less.
[8]A polyimide film including the polyimide according to [6] or [7].
[9] The polyimide film according to [8], having a transmittance of light having a wavelength of 400 nm of 30% or more.
[10] The polyimide film according to [8] or [9], having a haze of 1.0% or less.
[11] The polyimide film according to any one of [8] to [10], having a yellowness index of 15 or less.
[12]A laminate including a support and the polyimide film according to any one of [8] to [11].
[13]A method of producing a laminate including a support and a polyimide film, the method including:
applying the polyamic acid composition according to any one of [3] to [5] onto a support to form a coating film containing the polyamic acid and heating the coating film to imidize the polyamic acid.
[14] An electronic device including the polyimide film according to any one of [8] to [11] and an electronic element disposed on the polyimide film.

The polyimide produced using the polyamic acid according to one or more embodiments of the present invention is excellent in transparency and capable of suppressing generation of hydrogen fluoride during a high-temperature process. Therefore, the polyimide produced using the polyamic acid according to one or more embodiments of the present invention is suitable as a material of an electronic device required to have transparency and produced through a high-temperature process.

### DETAILED DESCRIPTION

One or more embodiments of the present invention will be described in detail below, but the present invention is not limited to these embodiments. The academic documents and the patent documents mentioned in the present description are incorporated in the present description by reference in their entirety.

First, terms used in the present description will be described. The term “structural unit” refers to a repeating unit included in a polymer. The term “polyamic acid” refers to a polymer including a structural unit represented by General Formula (14) described below (hereinafter, sometimes described as “structural unit (14)”).

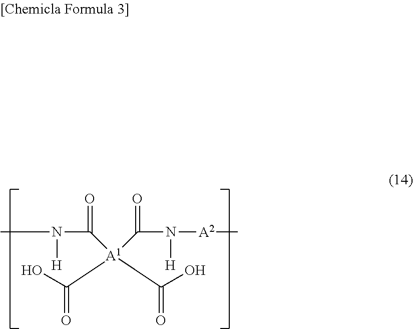

In General Formula (14), A¹ represents a tetracarboxylic dianhydride residue (tetravalent organic group derived from a tetracarboxylic dianhydride), and A² represents a diamine residue (divalent organic group derived from a diamine).

The content of the structural unit (14) with respect to all of the structural units included in the polyamic acid may be, for example, 50 mol % or more and 100 mol % or less, 60 mol % or more and 100 mol % or less, 70 mol % or more and 100 mol % or less, 80 mol % or more and 100 mol % or less, 90 mol % or more and 100 mol % or less, or 100 mol %.

The value “m/z” is a measurement value that can be read from the horizontal axis of a mass spectrum, which is a measurement result of mass spectrometry, and “m/z” is “a dimensionless quantity obtained by dividing the mass of an ion by the unified atomic mass unit (dalton) to obtain a dimensionless quantity and further dividing the dimensionless quantity by the absolute value of the charge number of the ion”.

Hereinafter, the name of a compound may be followed by the term “-based” to collectively refer to the compound and its derivatives. The term “-based” following the name of a compound to express the name of a polymer means that repeating units of the polymer are derived from the compound or its derivative, unless otherwise specified. A tetracarboxylic dianhydride may be referred to as “acid dianhydride”. The components, the functional groups, and the like shown in the present description may be used singly or in combination of two or more kinds thereof, unless otherwise specified.

### EMBODIMENTS OF PRESENT INVENTION

The polyamic acid according to the present embodiment (hereinafter, sometimes referred to as “specific polyamic acid”) includes a tetracarboxylic dianhydride residue and a diamine residue.

In the specific polyamic acid, the diamine residue includes a divalent organic group represented by General Formula (1) described below (hereinafter, sometimes referred to as “specific diamine residue”). That is, the specific polyamic acid includes a specific diamine residue as the diamine residue. In the specific polyamic acid, the tetracarboxylic dianhydride residue includes one or more residues (hereinafter, sometimes referred to as “specific acid dianhydride residues”) selected from the group consisting of a tetravalent organic group represented by Chemical Formula (2) described below, a tetravalent organic group represented by Chemical Formula (3) described below, a tetravalent organic group represented by Chemical Formula (4) described below, a tetravalent organic group represented by Chemical Formula (5) described below, a tetravalent organic group represented by Chemical Formula (6) described below, a tetravalent organic group represented by Chemical Formula (7) described below, a tetravalent organic group represented by Chemical Formula (8) described below, a tetravalent organic group represented by Chemical Formula (9) described below, and a tetravalent organic group represented by Chemical Formula (10) described below. That is, the specific polyamic acid includes a specific acid dianhydride residue as the tetracarboxylic dianhydride residue.

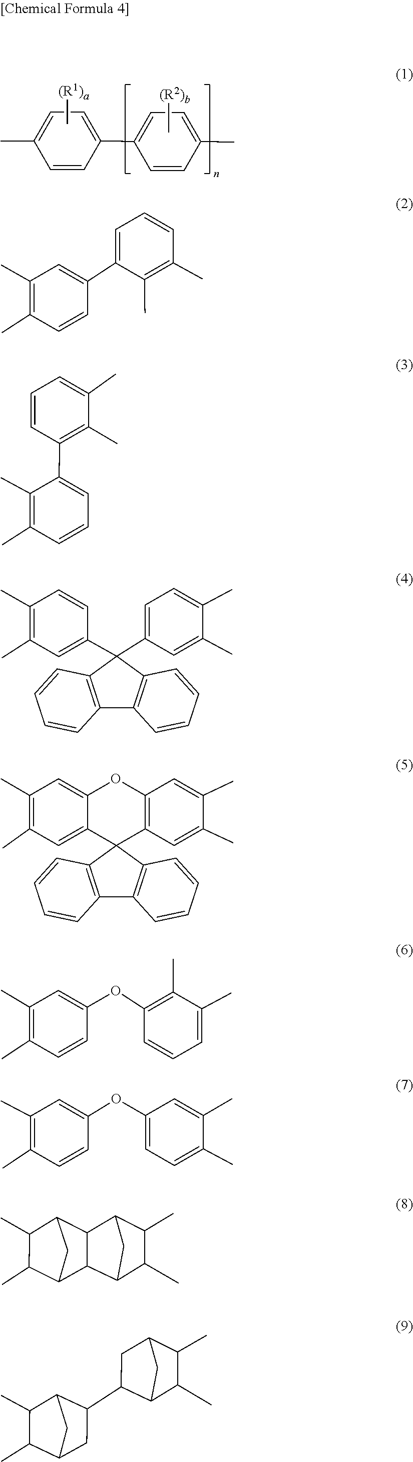

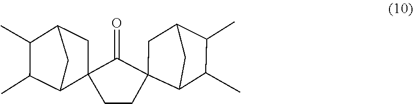

In General Formula (1), R¹ and R² each independently represent a trifluoromethoxy group, a pentafluoroethoxy group, or a heptafluoropropoxy group, a represents an integer of 1 or more and 4 or less, b represents an integer of 0 or more and 4 or less, a plurality of R¹s are optionally equal to or different from each other in a case where a represents an integer of 2 or more and 4 or less, a plurality of R²s are optionally equal to or different from each other in a case where b represents an integer of 2 or more and 4 or less, and n represents an integer of 0 or more and 3 or less. In General Formula (1), a and b may be equal to or different from each other.

The tetravalent organic group represented by Chemical Formula (2) is a partial structure (residue) derived from 2,3,3′,4′-biphenyltetracarboxylic dianhydride (hereinafter, sometimes referred to as “a-BPDA”). The tetravalent organic group represented by Chemical Formula (3) is a partial structure (residue) derived from 2,2′,3,3′-biphenyltetracarboxylic dianhydride (hereinafter, sometimes referred to as “i-BPDA”). The tetravalent organic group represented by Chemical Formula (4) is a partial structure (residue) derived from 9,9-bis(3,4-dicarboxyphenyl)fluorene dianhydride (hereinafter, sometimes referred to as “BPAF”). The tetravalent organic group represented by Chemical Formula (5) is a partial structure (residue) derived from spiro[11H-difuro[3,4-b:3′,4′-i]xanthene-11,9′-[9H]fluorene]-1,3,7,9-tetrone (hereinafter, sometimes referred to as “SFDA”). The tetravalent organic group represented by Chemical Formula (6) is a partial structure (residue) derived from 3,4′-oxydiphthalic anhydride (hereinafter, sometimes referred to as “a-ODPA”). The tetravalent organic group represented by Chemical Formula (7) is a partial structure (residue) derived from 4,4′-oxydiphthalic anhydride (hereinafter, sometimes referred to as “ODPA”). The tetravalent organic group represented by Chemical Formula (8) is a partial structure (residue) derived from decahydro-1H,3H-4,10:5,9-dimethanonaphtho[2,3-c:6,7-c′]difuran-1,3,6,8-tetraone (hereinafter, sometimes referred to as “DNDA”). The tetravalent organic group represented by Chemical Formula (9) is a partial structure (residue) derived from 5,5′-bis-2-norbornene-5,5′,6,6′-tetracarboxylic acid-5,5′,6,6′-dianhydride (hereinafter, sometimes referred to as “BNBDA”). The tetravalent organic group represented by Chemical Formula (10) is a partial structure (residue) derived from norbornane-2-spiro-α-cyclopentanone-α′-spiro-2″-norbornane-5,5″,6,6″-tetracarboxylic dianhydride (hereinafter, sometimes referred to as “CpODA”).

The polyimide produced using the specific polyamic acid is excellent in transparency and capable of suppressing generation of hydrogen fluoride during a high-temperature process. The reason for this is presumed as follows.

The specific polyamic acid includes the specific diamine residue including a fluorine atom and the specific acid dianhydride residue capable of suppressing aggregation of polymer chains. Therefore, in the polyimide produced using the specific polyamic acid, formation of a CT complex is suppressed. Therefore, the polyimide produced using the specific polyamic acid is excellent in transparency.

In the specific diamine residue, a fluoroalkyl group is bonded to an aromatic ring via an oxygen atom. Therefore, even if the polyimide produced using the specific polyamic acid is exposed to a high-temperature environment, hydrogen fluoride is less likely to be generated. Thus, the polyimide produced using the specific polyamic acid can suppress generation of hydrogen fluoride during a high-temperature process.

As long as performance of the specific polyamic acid is not impaired, the specific polyamic acid may include a residue having a structure in which a fluoroalkyl group (for example, a trifluoromethyl group, a pentafluoroethyl group, a heptafluoropropyl group, or the like) is directly bonded to a carbon atom (for example, a 2,2′-bis(trifluoromethyl)benzidine residue, a 4,4′-(hexafluoroisopropylidene)diphthalic anhydride residue, or the like). However, in order to further suppress generation of hydrogen fluoride during a high-temperature process, the content of the residue having a structure in which a fluoroalkyl group is directly bonded to a carbon atom may be 0.1 wt % or less, or 0.01 wt % or less with respect to the total amount (100 wt %) of the specific polyamic acid. In order to still further suppress generation of hydrogen fluoride during a high-temperature process, the specific polyamic acid may be a polyamic acid that does not include a residue having a structure in which a fluoroalkyl group is directly bonded to a carbon atom.

In order to further suppress generation of hydrogen fluoride during a high-temperature process, R¹ and R² in General Formula (1) may represent a trifluoromethoxy group. In order to further suppress generation of hydrogen fluoride during a high-temperature process, a in General Formula (1) may represent 1 or 2, and more preferably represents 1. In order to further suppress generation of hydrogen fluoride during a high-temperature process, b in General Formula (1) may represent an integer of 0 or more and 2 or less, or may represent 0 or 1.

In order to reduce the CTE of the resulting polyimide while enhancing the solubility of the specific polyamic acid in an organic solvent, n in General Formula (1) may represent 1 or 2, or may represent 1.

In order to obtain a polyimide that is more excellent in transparency and capable of further suppressing generation of hydrogen fluoride during a high-temperature process, the specific diamine residue may be one or more selected from the group consisting of a residue derived from 2,2′-bis(trifluoromethoxy)benzidine (hereinafter, sometimes referred to as “TFMOB”), a residue derived from 3,3′-bis(trifluoromethoxy)benzidine, and a residue derived from 2,3′-bis(trifluoromethoxy)benzidine, or may be a TFMOB residue.

The specific polyamic acid including the specific diamine residue is excellent in solubility because the specific polyamic acid includes fluorine. Imparting photosensitivity to the specific polyamic acid enables use of the specific polyamic acid in a material for pattern formation and a material required to have planarization performance.

In synthesis of the specific polyamic acid, a diamine monomer (another diamine) can also be used other than the diamine for formation of the specific diamine residue. Examples of another diamine include p-phenylenediamine, 1,3-bis(3-aminopropyl)tetramethyldisiloxane, 9,9-bis(4-aminophenyl)fluorene, 4,4′-diaminodiphenyl sulfone, 4,4′-diaminobenzanilide, m-phenylenediamine, 4,4′-oxydianiline, 3,4′-oxydianiline, N,N′-bis(4-aminophenyl)terephthalamide, m-tolidine, o-tolidine, 4,4′-bis(4-aminophenoxy)biphenyl, 2-(4-aminophenyl)-6-aminobenzoxazole, 3,5-diaminobenzoic acid, 4,4′-diamino-3,3′-dihydroxybiphenyl, 4,4′-methylenebis(cyclohexanamine), and derivatives thereof, and these may be used singly or in combination of two or more kinds thereof.

In order to obtain a polyimide more excellent in transparency, the content of the specific diamine residue may be 50 mol % or more, 70 mol % or more, 80 mol % or more, or 90 mol % or more, and may be 100 mol % with respect to the total amount (100 mol %) of diamine residues included in the specific polyamic acid.

In order to obtain a polyimide more excellent in transparency, the specific acid dianhydride residue may be one or more residues selected from the group consisting of an a-BPDA residue, an i-BPDA residue, a BPAF residue, and an SFDA residue, or may be one or more residues selected from the group consisting of an a-BPDA residue, a BPAF residue, and an SFDA residue.

In order to obtain a polyimide excellent in heat resistance and transparency, the specific acid dianhydride residue may be one or more residues selected from the group consisting of a BPAF residue and an SFDA residue. In order to obtain a polyimide excellent in heat resistance while enhancing the solubility of the specific polyamic acid, the specific acid dianhydride residue may be one or more residues selected from the group consisting of an a-BPDA residue and an i-BPDA residue. In order to obtain a polyimide excellent in a mechanical property, the specific acid dianhydride residue may be one or more residues selected from the group consisting of an a-ODPA residue and an ODPA residue. In order to further suppress formation of a CT complex, the specific acid dianhydride residue may be one or more residues selected from the group consisting of a DNDA residue, a BNBDA residue, and a CpODA residue.

In synthesis of the specific polyamic acid, an acid dianhydride monomer (another acid dianhydride) can also be used other than the acid dianhydride for formation of the specific acid dianhydride residue. Examples of another acid dianhydride include pyromellitic dianhydride (hereinafter, sometimes referred to as “PMDA”), 3,3′,4,4′-biphenyltetracarboxylic dianhydride (hereinafter, sometimes referred to as “s-BPDA”), 2,3,6,7-naphthalenetetracarboxylic dianhydride (hereinafter, sometimes referred to as “NTCDA”), 1,2,5,6-naphthalenetetracarboxylic dianhydride, p-phenylenebis(trimellitate anhydride), 3,3′,4,4′-benzophenonetetracarboxylic dianhydride, dicyclohexyl-3,3′,4,4′-tetracarboxylic dianhydride, 1,2,4,5-cyclohexanetetracarboxylic dianhydride, 1,2,3,4-cyclobutanetetracarboxylic dianhydride, and derivatives thereof, and these may be used singly or in combination of two or more kinds thereof.

In order to obtain a polyimide that is excellent in heat resistance and capable of reducing the CTE by combining another acid dianhydride residue with the specific diamine residue, another acid dianhydride residue may be one or more selected from the group consisting of an s-BPDA residue, an NTCDA residue, and a PMDA residue, or may be one or more selected from the group consisting of an s-BPDA residue and an NTCDA residue. In order to reduce the internal stress between a support and a polyimide film in formation of a polyimide film described below, another acid dianhydride residue may be an NTCDA residue. The s-BPDA residue is a tetravalent organic group represented by Chemical Formula (11) described below. The NTCDA residue is a tetravalent organic group represented by Chemical Formula (12) described below. The PMDA residue is a tetravalent organic group represented by Chemical Formula (13) described below.

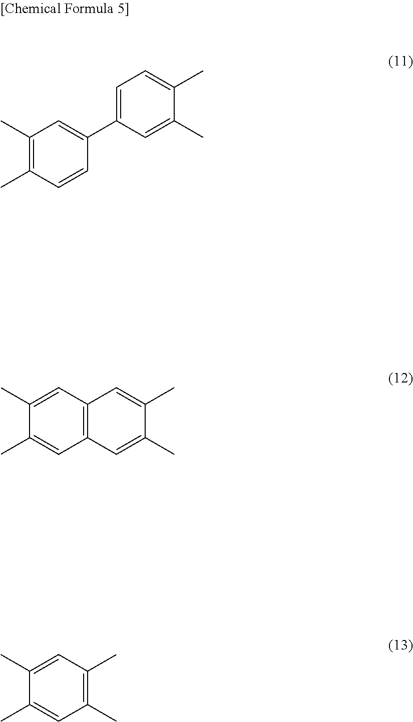

In order to obtain a polyimide more excellent in transparency, the content of the specific acid dianhydride residue (in the case of using a plurality of specific acid dianhydride residues, the total content thereof) may be 5 mol % or more, 10 mol % or more, 20 mol % or more, 30 mol % or more, 40 mol % or more, 50 mol % or more, 60 mol % or more, 70 mol % or more, 80 mol % or more, or 100 mol % with respect to the total amount (100 mol %) of tetracarboxylic dianhydride residues included in the specific polyamic acid.

In a case where the specific polyamic acid includes an a-BPDA residue as the specific acid dianhydride residue, in order to obtain a polyimide more excellent in transparency, the content of the a-BPDA residue may be 10 mol % or more and 50 mol % or less, or 20 mol % or more and 40 mol % or less with respect to the total amount (100 mol %) of tetracarboxylic dianhydride residues included in the specific polyamic acid.

In a case where the specific polyamic acid includes an i-BPDA residue as the specific acid dianhydride residue, in order to obtain a polyimide more excellent in transparency, the content of the i-BPDA residue may be 10 mol % or more and 50 mol % or less, or 20 mol % or more and 40 mol % or less with respect to the total amount (100 mol %) of tetracarboxylic dianhydride residues included in the specific polyamic acid.

In a case where the specific polyamic acid includes a BPAF residue as the specific acid dianhydride residue, in order to obtain a polyimide more excellent in transparency, the content of the BPAF residue may be 5 mol % or more and 100 mol % or less, or 10 mol % or more and 100 mol % or less with respect to the total amount (100 mol %) of tetracarboxylic dianhydride residues included in the specific polyamic acid.

In a case where the specific polyamic acid includes an SFDA residue as the specific acid dianhydride residue, in order to obtain a polyimide more excellent in transparency, the content of the SFDA residue may be 5 mol % or more and 100 mol % or less, 10 mol % or more and 100 mol % or less, 20 mol % or more and 100 mol % or less, or 30 mol % or more and 100 mol % or less with respect to the total amount (100 mol %) of tetracarboxylic dianhydride residues included in the specific polyamic acid.

In order to obtain a polyimide that is more excellent in heat resistance and capable of further reducing the CTE, the content of the one or more residues selected from the group consisting of an s-BPDA residue, an NTCDA residue, and a PMDA residue may be 10 mol % or more and 95 mol % or less, 20 mol % or more and 90 mol % or less, 30 mol % or more and 90 mol % or less, or 40 mol % or more and 85 mol % or less with respect to the total amount (100 mol %) of tetracarboxylic dianhydride residues included in the specific polyamic acid.

In order to obtain a polyimide more excellent in heat resistance, the content of the s-BPDA residue may be 10 mol % or more and 95 mol % or less, 20 mol % or more and 90 mol % or less, 30 mol % or more and 90 mol % or less, or 40 mol % or more and 85 mol % or less with respect to the total amount (100 mol %) of tetracarboxylic dianhydride residues included in the specific polyamic acid.

In order to obtain a polyimide capable of further reducing the internal stress, the content of the NTCDA residue may be 5 mol % or more and 75 mol % or less, 10 mol % or more and 70 mol % or less, 15 mol % or more and 60 mol % or less, 20 mol % or more and 60 mol % or less, 25 mol % or more and 60 mol % or less, 30 mol % or more and 60 mol % or less, 35 mol % or more and 60 mol % or less, or 40 mol % or more and 60 mol % or less with respect to the total amount (100 mol %) of tetracarboxylic dianhydride residues included in the specific polyamic acid.

In a case where the specific polyamic acid includes the one or more selected from the group consisting of an s-BPDA residue, an NTCDA residue, and a PMDA residue, in order to obtain a polyimide that is more excellent in transparency and heat resistance and capable of further reducing the CTE, the total content of the specific acid dianhydride residue, the s-BPDA residue, the NTCDA residue, and the PMDA residue may be 60 mol % or more, 70 mol % or more, 80 mol % or more, 90 mol % or more, or 100 mol % with respect to the total amount (100 mol %) of tetracarboxylic dianhydride residues included in the specific polyamic acid.

In order to obtain a polyimide that is further excellent in transparency and capable of further suppressing generation of hydrogen fluoride during a high-temperature process, the specific polyamic acid may satisfy Condition 1 described below. In order to obtain a polyimide that is further excellent in transparency and heat resistance and capable of further suppressing generation of hydrogen fluoride during a high-temperature process, the specific polyamic acid may satisfy Conditions 1 and 2 described below. In order to obtain a polyimide that is further excellent in transparency and capable of further suppressing generation of hydrogen fluoride during a high-temperature process while reducing the internal stress, the specific polyamic acid may satisfy Conditions 1 and 3 described below.

Condition 1: The content of the specific acid dianhydride residue (in the case of using a plurality of specific acid dianhydride residues, the total content thereof) is 5 mol % or more with respect to the total amount (100 mol %) of tetracarboxylic dianhydride residues included in the specific polyamic acid, and the content of the specific diamine residue is 50 mol % or more with respect to the total amount (100 mol %) of diamine residues included in the specific polyamic acid.

Condition 2: The specific polyamic acid includes an s-BPDA residue, and the content of the s-BPDA residue is 10 mol % or more and 95 mol % or less with respect to the total amount (100 mol %) of tetracarboxylic dianhydride residues included in the specific polyamic acid.

Condition 3: The specific polyamic acid includes an NTCDA residue, and the content of the NTCDA residue is 5 mol % or more and 75 mol % or less with respect to the total amount (100 mol %) of tetracarboxylic dianhydride residues included in the specific polyamic acid.

The specific polyamic acid can be synthesized with a known general method, and can be obtained, for example, by reacting a diamine with a tetracarboxylic dianhydride in an organic solvent. An example of a specific synthesis method of the specific polyamic acid will be described. First, in an atmosphere of an inert gas such as argon or nitrogen, a diamine is dissolved or dispersed in a slurry form in an organic solvent to prepare a diamine solution. Then, a tetracarboxylic dianhydride in a state of being dissolved or dispersed in a slurry form in an organic solvent, or a tetracarboxylic dianhydride in a solid state is added to the diamine solution.

In the case of synthesizing the specific polyamic acid using a diamine and a tetracarboxylic dianhydride, the desired specific polyamic acid (polymer of the diamine and the tetracarboxylic dianhydride) can be obtained by adjusting the substance amount of the diamine (substance amount of each diamine in the case of using a plurality of diamines) and the substance amount of the tetracarboxylic dianhydride (substance amount of each tetracarboxylic dianhydride in the case of using a plurality of tetracarboxylic dianhydrides). The molar fraction of each residue in the specific polyamic acid is equal to, for example, the molar fraction of each monomer (each monomer corresponding to each residue) used for synthesis of the specific polyamic acid. A specific polyamic acid containing a plurality of tetracarboxylic dianhydride residues and a plurality of diamine residues can also be obtained by blending two polyamic acids. The temperature condition for the reaction of the diamine and the tetracarboxylic dianhydride, that is, the synthesis reaction of the specific polyamic acid is not particularly limited, and is, for example, in the range of 20 °C or higher and 150 °C or lower. The reaction time for the synthesis reaction of the specific polyamic acid is, for example, in the range of 10 minutes or more and 30 hours or less.

The organic solvent used for synthesis of the specific polyamic acid may be a solvent capable of dissolving the tetracarboxylic dianhydride and the diamine to be used, or a solvent capable of dissolving the specific polyamic acid to be generated. Examples of the organic solvent used for synthesis of the specific polyamic acid include urea-based solvents such as tetramethylurea and N,N-dimethylethylurea; sulfoxide-based solvents such as dimethyl sulfoxide; sulfone-based solvents such as diphenyl sulfone and tetramethyl sulfone; amide-based solvents such as N,N-dimethylacetamide (DMAC), N,N-dimethylformamide (DMF), N,N-diethylacetamide, N-methyl-2-pyrrolidone (NMP), 3-methoxy-N,N-dimethylpropanamide (MPA), and hexamethylphosphoric triamide; ester-based solvents such as γ-butyrolactone; alkyl halide-based solvents such as chloroform and methylene chloride; aromatic hydrocarbon-based solvents such as benzene and toluene; phenol-based solvents such as phenol and cresol; ketone-based solvents such as cyclopentanone; and ether-based solvents such as tetrahydrofuran, 1,3-dioxolane, 1,4-dioxane, dimethyl ether, diethyl ether, diethylene glycol diethyl ether, diethylene glycol dimethyl ether, and p-cresol methyl ether. These solvents are usually used singly, and may be appropriately used in combination of two or more kinds thereof as necessary. In order to enhance the solubility and the reactivity of the specific polyamic acid, the organic solvent used for the synthesis reaction of the specific polyamic acid may be one or more solvents selected from the group consisting of amide-based solvents, ketone-based solvents, ester-based solvents, and ether-based solvents, or an amide-based solvent (more specifically, DMF, DMAC, NMP, MPA, or the like). The synthesis reaction of the specific polyamic acid may be performed under an atmosphere of an inert gas such as argon or nitrogen.

The weight average molecular weight of the specific polyamic acid may be in the range of 10,000 or more and 1,000,000 or less, in the range of 20,000 or more and 500,000 or less, or in the range of 30,000 or more and 200,000 or less although depending on the use of the specific polyamic acid. If the weight average molecular weight is 10,000 or more, the specific polyamic acid or a polyimide obtained using the specific polyamic acid is easily formed into a coating film or a polyimide film (film). Meanwhile, if the weight average molecular weight is 1,000,000 or less, the specific polyamic acid exhibits sufficient solubility in a solvent, and therefore a coating film or a polyimide film having a smooth surface and a uniform thickness can be obtained using the polyamic acid composition described below. The weight average molecular weight used herein refers to a value in terms of polyethylene oxide measured using gel permeation chromatography (GPC).

Examples of a method of controlling the molecular weight of the specific polyamic acid include a method in which an acid dianhydride or a diamine is excessively used, and a method in which a monofunctional acid anhydride such as phthalic anhydride or a monofunctional amine such as aniline is reacted to quench the reaction. In a case where an acid dianhydride or a diamine is excessively used for polymerization, a polyimide film having sufficient strength can be obtained as long as the molar ratio of the diamine to the acid dianhydride for preparation is in the range from 0.95 to 1.05. The above-described molar ratio of the diamine to the acid dianhydride for preparation is the ratio of the total substance amount of the diamine used for synthesis of the specific polyamic acid to the total substance amount of the acid dianhydride used for synthesis of the specific polyamic acid (total substance amount of diamine/total substance amount of acid dianhydride). It is also possible to use phthalic anhydride, maleic anhydride, aniline, or the like for end-capping to further reduce coloring of the polyimide obtained using the specific polyamic acid.

The polyamic acid composition according to the present embodiment contains the specific polyamic acid and an organic solvent. Examples of the organic solvent contained in the polyamic acid composition include the organic solvents exemplified as the organic solvent usable in the synthesis reaction of the specific polyamic acid, and the organic solvent contained in the polyamic acid composition may be one or more solvents selected from the group consisting of amide-based solvents, ketone-based solvents, ester-based solvents, and ether-based solvents, or an amide-based solvent (more specifically, DMF, DMAC, NMP, MPA, or the like). In the case of obtaining the specific polyamic acid with the above-described method, the reaction solution (solution after the reaction) itself may be used as the polyamic acid composition according to the present embodiment. Alternatively, the solid specific polyamic acid obtained by removing the solvent from the reaction solution may be dissolved in an organic solvent to prepare the polyamic acid composition according to the present embodiment. The content of the specific polyamic acid in the polyamic acid composition according to the present embodiment is not particularly limited, and is, for example, 1 wt % or more and 80 wt % or less with respect to the total amount of the polyamic acid composition.

The polyamic acid composition according to the present embodiment may further contain one or more compounds selected from the group consisting of tertiary amines, phosphorus-containing compounds, and phenolic compounds (hereinafter, sometimes referred to as “specific additives”). In the present description, the specific additive is a compound different from a polyamic acid and a solvent. If the polyamic acid composition according to the present embodiment contains the specific additive, sufficient molecular motion is imparted to the specific polyamic acid during imidization. As a result, imidization of the specific polyamic acid rapidly proceeds, depolymerization of the specific polyamic acid is also suppressed, and occurrence of outgassing (in particular, of hydrogen fluoride) can be further suppressed. In order to further enhance the molecular mobility of the specific polyamic acid during imidization, the specific additive may be one or more compounds selected from the group consisting of tertiary amines and phosphorus-containing compounds.

In order to further enhance the molecular mobility of the specific polyamic acid during imidization, the specific additive may be a compound having a molecular weight of 1500 or less. In order to further enhance the molecular mobility of the specific polyamic acid during imidization, the specific additive may be a compound soluble in the organic solvent in the polyamic acid composition.

In order to further enhance the molecular mobility of the specific polyamic acid during imidization, the specific additive may be a compound having a boiling point of 150 °C or higher, a compound having a boiling point of 200 °C or higher, or a compound having a boiling point of 250 °C or higher. In order to further enhance the molecular mobility of the specific polyamic acid during imidization, the specific additive may be a compound that does not have a decomposition temperature within the temperature range of the boiling point or lower. In order to further enhance the molecular mobility of the specific polyamic acid during imidization, the specific additive may have a higher boiling point than the organic solvent in the polyamic acid composition.

In order to suppress deterioration of a property of the polyimide caused by decomposition of the specific additive while further enhancing the molecular mobility of the specific polyamic acid during imidization, the content of the specific additive may be 0.001 parts by weight or more and 20 parts by weight or less, 0.01 parts by weight or more and 15 parts by weight or less, or 0.1 parts by weight or more and 10 parts by weight or less with respect to 100 parts by weight of the specific polyamic acid.

The method of mixing the specific polyamic acid and the specific additive is not particularly limited. From the viewpoint of ease of molecular weight control of the specific polyamic acid, the specific additive may be added to the specific polyamic acid after polymerization. At this time, the specific additive may be added as it is to the specific polyamic acid, or a solution obtained by dissolving the specific additive in a solvent in advance may be added to the specific polyamic acid, and thus the addition method is not particularly limited. The specific additive may be added to a solution containing the specific polyamic acid after polymerization (solution after the reaction) to prepare the polyamic acid composition according to the present embodiment.

The tertiary amine used as the specific additive is coordinated to a carboxy group of the specific polyamic acid, and thus the tertiary amine also functions as an imidization accelerator described below. If the tertiary amine is contained in an amount of 0.001 parts by weight or more with respect to 100 parts by weight of the specific polyamic acid, the CTE of the resulting polyimide film can be reduced while the strength and the transparency of the resulting polyimide film are improved. Examples of the tertiary amine include alkylamine-based compounds such as triethylamine, diisopropylamine, dibutylamine, and N,N-dimethylbutylamine; and heterocyclic compounds such as pyridine, 3,5-lutidine, and imidazole-based compounds.

In particular, an imidazole-based compound is easily coordinated to a carboxy group of the specific polyamic acid, and therefore if an imidazole-based compound is used as the tertiary amine, imidization of the specific polyamic acid more rapidly proceeds. Thus, the organic solvent such as NMP is less likely to remain in the polyimide film during thermal imidization, and at the same time, decomposition of the specific polyamic acid is suppressed, and therefore the transparency of the resulting polyimide film is considered to be improved.

In the present description, the term “imidazole-based compound” refers to a compound having a 1,3-diazole ring (1,3-diazole ring structure). The imidazole-based compound that can be added to the polyamic acid composition according to the present embodiment is not particularly limited, and examples of the imidazole-based compound include 1H-imidazole, 2-methylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, and 1-benzyl-2-phenylimidazole. Among them, 2-phenylimidazole, 1,2-dimethylimidazole, 1-benzyl-2-methylimidazole, and 1-benzyl-2-phenylimidazole are preferable, and 2-phenylimidazole, 1,2-dimethylimidazole, and 1-benzyl-2-methylimidazole are more preferable.

Examples of the phosphorus-containing compounds include compounds represented by General Formulas (15-1) to (15-10) described below. In General Formulas (15-1) to (15-10) described below, R⁵, R⁶, and R⁷ each independently represent a hydrogen atom, a monovalent organic group, or a polyvalent organic group, R⁸ represents a polyvalent organic group, and m represents the degree of polymerization.

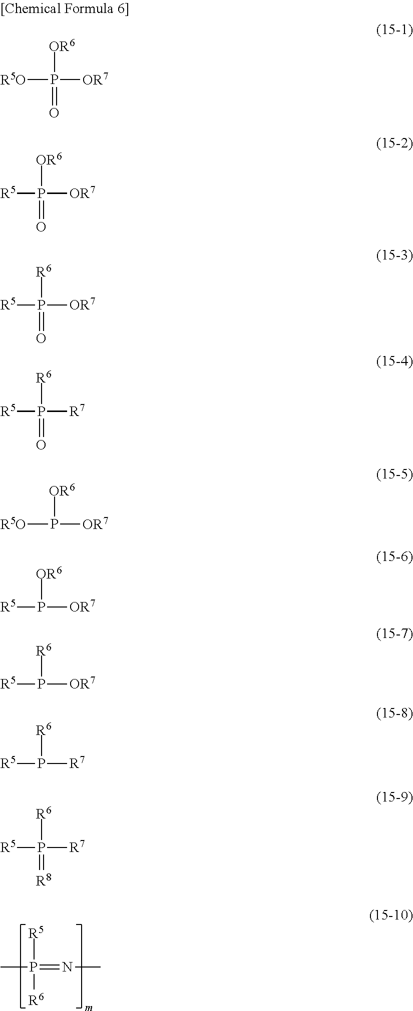

Examples of the phosphorus-containing compound include phosphoric acid-based compounds, phosphorous acid-based compounds, phosphonic acid-based compounds, phosphinic acid-based compounds, phosphine-based compounds, phosphine oxide-based compounds, phosphorane-based compounds, and phosphazene-based compounds. The phosphorus-containing compound may be an ester or a condensate of a compound listed above, or may include a cyclic structure, or may form a salt with an amine or the like. Some of these phosphorus-containing compounds have a tautomeric relationship like a phosphorous acid-based compound and a phosphonic acid-based compound, and the phosphorus-containing compounds may exist in either state.

Specific examples of the phosphoric acid-based compounds include trimethyl phosphate, triethyl phosphate, tributyl phosphate, tri(2-ethylhexyl)phosphate, tributoxyethyl phosphate, triphenyl phosphate, tricresyl phosphate, trixylenyl phosphate, tris(isopropylphenyl)phosphate, trinaphthyl phosphate, cresyl diphenyl phosphate, xylenyl diphenyl phosphate, diphenyl(2-ethylhexyl)phosphate, di(isopropylphenyl) phenyl phosphate, monoisodecyl phosphate, 2-acryloyloxyethyl acid phosphate, 2-methacryloyloxyethyl acid phosphate, diphenyl-2-acryloyloxyethyl phosphate, diphenyl-2-methacryloyloxyethyl phosphate, melamine phosphate, dimelamine phosphate, bisphenol A bis(diphenyl phosphate), and tris(p-chloropropyl)phosphate.

Specific examples of the phosphorous acid-based compounds include triphenyl phosphite, tris nonylphenyl phosphite, tricresyl phosphite, triethyl phosphite, triisobutyl phosphite, tris(2-ethylhexyl) phosphite, tridecyl phosphite, trilauryl phosphite, tris(tridecyl) phosphite, diphenyl phosphite, diethyl phosphite, dibutyl phosphite, dimethyl phosphite, diphenyl mono(2-ethylhexyl) phosphite, diphenyl monodecyl phosphite, diphenyl mono(tridecyl) phosphite, trilauryl trithiophosphite, diethyl hydrogen phosphite, bis(2-ethylhexyl) hydrogen phosphite, dilauryl hydrogen phosphite, dioleyl hydrogen phosphite, diphenyl hydrogen phosphite, tetraphenyl dipropylene glycol diphosphite, bis(decyl)pentaerythritol diphosphite, bis(tridecyl)pentaerythritol diphosphite, tristearyl phosphite, distearyl pentaerythritol diphosphite, tris(2,4-di-tert-butylphenyl) phosphite, triisodecyl phosphite, and 3,9-bis(2,6-di-tert-butyl-4-methylphenoxy)-2,4,8,10-tetraoxa-3,9-diphosphaspiro[5.5]undecane.

Examples of the condensate include condensed phosphate esters. Specific examples of the condensed phosphate esters include trialkyl polyphosphate, resorcinol polyphenyl phosphate, resorcinol poly(di-2,6-xylyl) phosphate, and hydroquinone poly(2,6-xylyl) phosphate. Examples of commercially available products of the condensed phosphate esters include “CR-733S” manufactured by DAIHACHI CHEMICAL INDUSTRY CO., LTD., “CR-741” manufactured by DAIHACHI CHEMICAL INDUSTRY CO., LTD., “PX-200” manufactured by DAIHACHI CHEMICAL INDUSTRY CO., LTD., and “FP-600” manufactured by ADEKA CORPORATION.

Specific examples of the phosphazene-based compounds include phenoxy cyclophosphazene (“FP-110” manufactured by FUSHIMI Pharmaceutical Co., Ltd.) and cyclic cyanophenoxy phosphazene (“FP-300” manufactured by FUSHIMI Pharmaceutical Co., Ltd.).

Examples of the phenolic compounds include hindered type, semi-hindered type, and less-hindered type phenolic compounds, and specific examples thereof include dibutylhydroxytoluene, 1,3,5-tris(3,5-di-t-butyl-4-hydroxyphenylmethyl)-2,4,6-trimethylbenzene, and acrylic acid 2-t-butyl-4-methyl-6-(2-hydroxy-3-t-butyl-5-methylbenzyl)phenyl ester.

The phenolic compound also functions as a primary antioxidant that traps a peroxy radical and converts the peroxy radical into a hydroperoxide to suppress automatic oxidation of a polymer. Therefore, the phenolic compound also has a function of suppressing coloring caused by oxidation of the polymer. Furthermore, coloring caused by oxidation of the polyimide can be further suppressed by combining the phenolic compound with a phosphite or the like having a function of a secondary antioxidant that converts a hydroperoxide into a stable alcohol compound. For example, coloring of the polyimide can be effectively suppressed by using a phosphite in the range of 1 equivalent or more and 10 equivalents or less with respect to the phenolic compound.

The polyamic acid composition according to the present embodiment may contain an imidization accelerator and/or a dehydration catalyst in order to shorten the heating time and exhibit a property.

The imidization accelerator is not particularly limited, and a tertiary amine can be used. The tertiary amine may be a heterocyclic tertiary amine. Examples of the heterocyclic tertiary amine include pyridine, picoline, quinoline, isoquinoline, and imidazole-based compounds. Examples of the dehydration catalyst include acetic anhydride, propionic anhydride, n-butyric anhydride, benzoic anhydride, and trifluoroacetic anhydride.

The amount of the imidization accelerator added may be 0.5 times molar equivalent or more and 5.0 times molar equivalent or less, 0.7 times molar equivalent or more and 2.5 times molar equivalent or less, or 0.8 times molar equivalent or more and 2.0 times molar equivalent or less with respect to the amide group of the specific polyamic acid. The amount of the dehydration catalyst added may be 0.5 times molar equivalent or more and 10.0 times molar equivalent or less, 0.7 times molar equivalent or more and 5.0 times molar equivalent or less, or 0.8 times molar equivalent or more and 3.0 times molar equivalent or less with respect to the amide group of the specific polyamic acid. In the present description, the term “amide group of the specific polyamic acid” refers to an amide group generated by a polymerization reaction between a diamine and a tetracarboxylic dianhydride. When added to the polyamic acid composition, the imidization accelerator and/or the dehydration catalyst may be directly added without being dissolved in an organic solvent, or may be dissolved in an organic solvent and the resulting solution may be added. In the method of direct addition without dissolution in an organic solvent, the reaction may rapidly proceed before diffusion of the imidization accelerator and/or the dehydration catalyst, resulting in generation of a gel. Therefore, a solution obtained by dissolving the imidization accelerator and/or the dehydration catalyst in an organic solvent may be added to the polyamic acid composition.

In the polyamic acid composition according to the present embodiment, various organic or inorganic low molecular weight compounds or polymer compounds may be blended as additives different from the above-described specific additive. Examples of a usable additive different from the specific additive include a plasticizer, an antioxidant, a dye, a surfactant, a leveling agent, silicone, fine particles, and a sensitizer. The fine particles include organic fine particles including polystyrene and polytetrafluoroethylene, and inorganic fine particles including colloidal silica, carbon, and layered silicate, and the fine particles may have a porous structure or a hollow structure. The function and the form of the fine particles are not particularly limited, and the fine particles may be, for example, a pigment, a filler, or fibrous particles.

In order to improve the heat resistance while maintaining the transparency of the resulting polyimide film, nanosilica particles may be used as the additive, and a composite of the specific polyamic acid and the nanosilica particles maybe formed. From the viewpoint of further enhancing the transparency of the polyimide film, the average primary particle size of the nanosilica particles may be 200 nm or less, 100 nm or less, 50 nm or less, or 30 nm or less. Meanwhile, from the viewpoint of ensuring the dispersibility in the specific polyamic acid, the average primary particle size of the nanosilica particles may be 5 nm or more, or 10 nm or more. As the method of forming a composite of the specific polyamic acid and the nanosilica particles, a known method can be used, and examples of the method include a method in which an organosilica sol obtained by dispersing nanosilica particles in an organic solvent is used. As the method of forming a composite of the specific polyamic acid and the nanosilica particles using the organosilica sol, a method may be used in which the specific polyamic acid is synthesized and then the synthesized specific polyamic acid and the organosilica sol are mixed. However, in order to disperse the nanosilica particles in the specific polyamic acid to a higher degree, the specific polyamic acid may be synthesized in the organosilica sol.

In order to enhance the interaction with the specific polyamic acid, the nanosilica particles can also be subjected to a surface treatment using a surface treatment agent. As the surface treatment agent, a known surface treatment agent such as a silane coupling agent can be used. As the silane coupling agent, alkoxysilane compounds including an amino group, a glycidyl group, or the like as a functional group are widely known, and can be appropriately selected. In order to further enhance the interaction with the specific polyamic acid, the silane coupling agent may be an amino group-containing alkoxysilane. Examples of the amino group-containing alkoxysilane include 3-aminopropyltrimethoxysilane, 3-aminopropyltriethoxysilane, 3-aminopropylmethyldimethoxysilane, 3-aminopropylmethyldiethoxysilane, 3-(2-aminoethyl)aminopropyltrimethoxysilane, 3-phenylaminopropyltrimethoxysilane, 2-aminophenyltrimethoxysilane, and 3-aminophenyltrimethoxysilane, and from the viewpoint of stability of the raw material, 3-aminopropyltriethoxysilane maybe used. Examples of the surface treatment method for the nanosilica particles include a method in which a mixture obtained by adding a silane coupling agent to a dispersion liquid (organosilica sol) is stirred under an atmospheric temperature of 20 °C or higher and 80 °C or lower. The stirring time at this time is, for example, 1 hour or more and 10 hours or less. At this time, a catalyst or the like that accelerates the reaction may be added.

A nanosilica-polyamic acid composite obtained by forming a composite of the specific polyamic acid and the nanosilica particles may contain the nanosilica particles in the range of 1 part by weight or more and 30 parts by weight or less, or 1 part by weight or more and 20 parts by weight or less with respect to 100 parts by weight of the specific polyamic acid. If the content of the nanosilica particles is 1 part by weight or more, the heat resistance of the nanosilica particle-containing polyimide can be improved and the internal stress can be sufficiently reduced, and if the content of the nanosilica particles is 30 parts by weight or less, adverse effects on a mechanical property and the transparency of the nanosilica particle-containing polyimide can be suppressed.

The polyamic acid composition according to the present embodiment can contain a silane coupling agent in order to develop appropriate adhesion to a support. Although a known silane coupling agent can be used without particular limitation, a compound containing an amino group is particularly preferable from the viewpoint of reactivity with the specific polyamic acid.

The ratio of the silane coupling agent blended to 100 parts by weight of the specific polyamic acid may be 0.01 parts by weight or more and 0.50 parts by weight or less, 0.01 parts by weight or more and 0.10 parts by weight or less, or 0.01 parts by weight or more and 0.05 parts by weight or less. If the ratio of the silane coupling agent blended is 0.01 parts by weight or more, the effect of suppressing peeling from a support is sufficiently exhibited, and if the ratio of the silane coupling agent blended is 0.50 parts by weight or less, a decrease in the molecular weight of the specific polyamic acid is suppressed, so that embrittlement of the polyimide film can be suppressed.

The polyimide according to the present embodiment is an imidized product of the above-described specific polyamic acid. The polyimide according to the present embodiment can be obtained with a known method, and the method of producing the polyimide is not particularly limited. Hereinafter, an example of the method will be described in which the specific polyamic acid is imidized to obtain the polyimide according to the present embodiment. The imidization is performed by subjecting the specific polyamic acid to cyclodehydration. The cyclodehydration can be performed with an azeotropic method using an azeotropic solvent, a thermal method, or a chemical method. The imidization from the specific polyamic acid to the polyimide can be performed at any percentage of 1% or more and 100% or less. That is, the specific polyamic acid that is partially imidized may be synthesized. In particular in the case of imidization by heating, the ring closure reaction from the specific polyamic acid to the polyimide and the hydrolysis of the specific polyamic acid proceed at the same time, and the resulting polyimide may have a lower molecular weight than the specific polyamic acid. Therefore, the specific polyamic acid in the polyamic acid composition may be partially imidized in advance before forming a polyimide film described below from the viewpoint of improving a mechanical property. In the present description, the partially imidized polyamic acid may also be referred to as “polyamic acid”.

The cyclodehydration of the specific polyamic acid is to be performed by heating the specific polyamic acid. The method of heating the specific polyamic acid is not particularly limited, and for example, a method may be used in which the polyamic acid composition according to the present embodiment described above is applied onto a support such as a glass substrate, a metal plate, or a polyethylene terephthalate film (PET film) and then the specific polyamic acid is heat-treated at a temperature in the range of 40 °C or higher and 500 °C or lower. This method provides a laminate according to the present embodiment including a support and a polyimide film (specifically, a polyimide film containing the imidized product of the specific polyamic acid) disposed on the support. Alternatively, cyclodehydration of the specific polyamic acid can be performed by directly putting the polyamic acid composition into a container subjected to a release treatment such as coating with a fluorine-based resin, and heating and drying the polyamic acid composition under reduced pressure. The polyimide can be obtained by cyclodehydration of the specific polyamic acid with these methods. The heating time in each treatment described above depends on the amount of the polyamic acid composition subjected to cyclodehydration and the heating temperature, but the heating time may be in the range of 1 minute or more and 300 minutes or less after the treatment temperature reaches the maximum temperature.

The polyimide film (specifically, polyimide film containing the imidized product of the specific polyamic acid) according to the present embodiment is colorless and transparent and has a low yellowness index and a glass transition temperature (heat resistance) to be resistant to a step of preparing a TFT, and therefore the polyimide film is suitable for a transparent substrate material of a flexible display. The content of the polyimide (specifically, imidized product of the specific polyamic acid) in the polyimide film according to the present embodiment may be, for example, 70 wt % or more, 80 wt % or more, 90 wt % or more, or 100 wt % with respect to the total amount of the polyimide film. Examples of the component other than the polyimide in the polyimide film include the above-described additives (more specifically, fine particles and the like).

An electronic device (more specifically, flexible device or the like) according to the present embodiment includes the polyimide film according to the present embodiment and an electronic element directly or indirectly disposed on the polyimide film. In the case of producing the electronic device according to the present embodiment for a flexible display, first, a polyimide film is formed on an inorganic substrate, such as glass, serving as a support. Then, an electronic element such as a TFT is disposed (formed) on the polyimide film to form an electronic device on the support. The step of forming a TFT is generally performed in a wide temperature range of 150 °C or higher and 650 °C or lower, and in order to actually achieve desired performance, an oxide semiconductor layer or an a-Si layer is formed at 300 °C or higher, and in some cases, a-Si or the like is further crystallized with a laser or the like.

At this time, if the polyimide film has a low thermal decomposition temperature, outgassing occurs during formation of an electronic element, and a sublimate may adhere to the inside of the oven to cause contamination in the furnace, or an inorganic film (a barrier film or the like described below) formed on the polyimide film or the electronic element may be peeled off. Therefore, the polyimide may have a 1% weight loss temperature of 500 °C or higher. The upper limit of the 1% weight loss temperature of the polyimide may be as high as possible, and may be, for example, 600 °C. The 1% weight loss temperature can be adjusted, for example, by changing the content of a residue having a rigid structure (more specifically, for example, an s-BPDA residue). More specifically, before forming a TFT, an inorganic film such as a silicon oxide film (SiOx film) or a silicon nitride film (SiNx film) is formed as a barrier film on the polyimide film. At this time, if the polyimide has low heat resistance, or progress of imidization is incomplete, or the amount of the residual solvent is large, a volatile component such as a decomposition gas of the polyimide may cause peeling of the polyimide and the inorganic film in a high-temperature process after layering of the inorganic film. Therefore, it is desirable that the polyimide has a 1% weight loss temperature of 500 °C or higher and that the polyimide isothermally held at a temperature in the range of 400 °C or higher and 450 °C or lower has a weight loss ratio of less than 1%.

As described above, the polyimide produced using the specific polyamic acid can suppress generation of hydrogen fluoride during a high-temperature process. Examples of an index of the amount of the hydrogen fluoride gas generated at the time of using the imidized product of the specific polyamic acid (polyimide according to the present embodiment) in a high-temperature process include the detection intensity ratio obtained from a mass spectrum. Specifically, first, the polyimide is heated at a temperature rise rate of 10 °C/min from an atmospheric temperature of 60 °C to 500 °C under a helium gas flow, and the gas generated from the polyimide is analyzed with a quadrupole mass spectrometer. Then, in the obtained mass spectrum, the detection intensity of a peak at m/z=20 (a peak estimated to be a peak due to hydrogen fluoride) at an atmospheric temperature of 450 °C is divided by the detection intensity of a peak at m/z=20 at an atmospheric temperature of 100 °C to obtain the calculated value. Hereinafter, the term “value obtained by dividing the detection intensity of a peak at m/z=20 at an atmospheric temperature of 450 °C by the detection intensity of a peak at m/z=20 at an atmospheric temperature of 100 °C” may be referred to as HF intensity ratio. The HF intensity ratio tends to increase as the amount of the hydrogen fluoride gas generated during a high-temperature process increases. The flow rate of the helium gas at the time of the analysis with a quadrupole mass spectrometer may be set so that the gas generated from the polyimide can be analyzed with the quadrupole mass spectrometer in real time, and the flow rate may be, for example, in the range of 50 mL/min or more and 150 mL/min or less, or in the range of 80 mL/min or more and 120 mL/min or less.

In order to obtain a polyimide capable of further suppressing generation of hydrogen fluoride during a high-temperature process, the HF intensity ratio may be 3.0 or less, or 2.5 or less. The lower limit of the HF intensity ratio is not particularly limited, and may be 0.

If the polyimide has a glass transition temperature (Tg) significantly lower than the process temperature, positional deviation or the like may occur during formation of an electronic element. Therefore, the polyimide may have a Tg of 300 °C or higher, 350 °C or higher, 400 °C or higher, or 420 °C or higher. The upper limit of the Tg of the polyimide may be as high as possible, and may be, for example, 470 °C. Furthermore, an internal stress is generated between the glass substrate and the polyimide film because a glass substrate generally has a smaller thermal expansion coefficient than a resin. If the laminate including the glass substrate used as a support, the electronic element, and the polyimide film has a high internal stress, the laminate including the polyimide film expands in the high-temperature TFT forming step, and then contracts when cooled to normal temperature to cause, for example, warpage and breakage of the glass substrate and peeling of the polyimide film from the glass substrate. Therefore, the laminate including the glass substrate (support) and the polyimide film (laminate according to the present embodiment) may have an internal stress between the polyimide film and the glass substrate of 50 MPa or less, 45 MPa or less, 40 MPa or less, 35 MPa or less, or 30 MPa or less. The lower limit of the internal stress may be as low as possible. The method of measuring the internal stress is the same as or similar to the method in Examples described below.

The polyimide according to the present embodiment can be suitably used as a material of a display substrate such as a TFT substrate or a touch panel substrate. In the above-described use of the polyimide, a method is often adopted in which an electronic device (specifically, electronic device in which an electronic element is formed on a polyimide film) is formed on a support as described above and then the polyimide film is peeled from the support. As a material of the support, alkali-free glass is suitably used. Hereinafter, an example of a method of producing a laminate including a polyimide film and a support will be described in detail.

First, the polyamic acid composition according to the present embodiment is applied (cast) onto a support to form a coating film-containing laminate that includes a coating film containing the specific polyamic acid and includes the support. Next, the coating film-containing laminate is heated under a condition of, for example, a temperature of 40 °C or higher and 200 °C or lower. The heating time at this time is, for example, 3 minutes or more and 120 minutes or less. A multi-stage heating step may be provided such that the coating film-containing laminate is heated at a temperature of 50 °C for 30 minutes and then heated at a temperature of 100 °C for 30 minutes. Next, in order to promote imidization of the specific polyamic acid in the coating film, the coating film-containing laminate is heated under a condition of, for example, a maximum temperature of 200 °C or higher and 500 °C or lower. The heating time (heating time at the maximum temperature) at this time is, for example, 1 minute or more and 300 minutes or less. At this time, the temperature may be raised gradually from a low temperature to the maximum temperature. The temperature rise rate may be 2 °C/min or more and 10 °C/min or less, or 4 °C/min or more and 10 °C/min or less. The maximum temperature maybe in the range of 250 °C or higher and 450 °C or lower. If the maximum temperature is 250 °C or higher, imidization sufficiently proceeds, and if the maximum temperature is 450 °C or lower, thermal deterioration of the polyimide can be suppressed. The temperature may be held at any temperature for any period of time until reaching the maximum temperature. The imidization reaction can be performed under air, under reduced pressure, or in an inert gas such as nitrogen, and in order to develop higher transparency, the imidization reaction may be performed under reduced pressure or in an inert gas such as nitrogen. As a heater, a known device such as a hot-air oven, an infrared oven, a vacuum oven, an inert oven, or a hot plate can be used. Through these steps, the specific polyamic acid in the coating film is imidized, and a laminate (that is, the laminate according to the present embodiment) can be obtained that includes the support and the polyimide film (film containing an imidized product of the specific polyamic acid).

As a method of peeling the polyimide film from the obtained laminate including the support and the polyimide film, a known method can be used. For example, the polyimide film may be peeled manually, or may be peeled using a machine such as a drive roll or a robot. Furthermore, a method can be adopted in which a peeling layer is provided between a support and a polyimide film, and a method can be adopted in which a silicon oxide film is formed on a substrate having a large number of grooves, a polyimide film is formed using the silicon oxide film as a base layer, and an etching solution of silicon oxide is introduced between the substrate and the silicon oxide film to peel the polyimide film. In addition, a method can be adopted in which a polyimide film is separated by irradiation with laser light.

The transparency of the polyimide film can be evaluated with the total light transmittance (TT) in accordance with JIS K 7361-1:1997 and the haze in accordance with JIS K 7136-2000. In a use of the polyimide film in which high transparency is required, the polyimide film may have a total light transmittance of 75% or more, or 80% or more. In a use of the polyimide film in which high transparency is required, the polyimide film may have a haze of 1.5% or less, 1.2% or less, 1.0% or less, or 0.8% or less, and the haze may be 0%. In a use in which high transparency is required, the polyimide film is required to have high transmittance in the entire wavelength region, but the polyimide film tends to absorb light on the short wavelength side, and the film itself is often colored yellow. For a use of the polyimide film in which high transparency is required, coloring of the polyimide film may be reduced. Specifically, for a use of the polyimide film in which high transparency is required, the polyimide film may have a yellowness index (YI) of 20 or less, or 15 or less, and the yellowness index may be 0. The YI can be measured in accordance with JIS K 7373-2006. As described above, the polyimide film in which coloring is reduced and transparency is imparted is suitable for a transparent substrate for use as a substitute for glass, or a substrate having a back surface on which a sensor or a camera module is provided.

In use in which transparency is required, the transmittance of blue light (light having a wavelength of around 470 nm) is particularly required to be high from the viewpoint of color reproducibility and the like, and practically, the transmittance of light having a wavelength of 400 nm (400 nm transmittance) is required to be high. From the viewpoint of color reproducibility and the like, the polyimide film may have a 400 nm transmittance of 30% or more, 40% or more, 50% or more, or 60% or more. The upper limit of the 400 nm transmittance of the polyimide film is not particularly limited, and may be 100%.

The light extraction systems of flexible displays are classified into two types: a top emission system that extracts light from the front surface side of a TFT; and a bottom emission system that extracts light from the back surface side of a TFT. The top emission system is characterized in that light is not blocked by the TFT and thus the aperture ratio can be easily increased to obtain high definition image quality, and the bottom emission system is characterized in that alignment between the TFT and the pixel electrode is easy and thus the production is facilitated. If the TFT is transparent, the aperture ratio can be improved even in the bottom emission system, and therefore a large display tends to adopt a bottom emission system, which is easy to produce. The polyimide film according to the present embodiment has a low YI and excellent heat resistance, and therefore can be applied to both of the light extraction systems described above.

In a batch-type device preparation process in which the polyamic acid composition is applied onto a support such as a glass substrate and imidized by heating, an electronic element or the like is formed, and then the polyimide film is peeled off, the adhesion between the support and the polyimide film may be excellent. The term “adhesion” as used herein means adhesive strength. In a preparation process in which an electronic element or the like is formed on a polyimide film on a support and then the polyimide film on which the electronic element or the like is formed is peeled from the support, if the adhesion between the polyimide film and the support is excellent, the electronic element or the like can be formed or mounted more accurately. In a production process in which an electronic element or the like is disposed on a support via a polyimide film, the peel strength between the support and the polyimide film may be as high as possible from the viewpoint of improving the productivity. Specifically, the peel strength may be 0.05 N/cm or more, or 0.1 N/cm or more.

In a production process as described above, when the polyimide film is peeled from the laminate including the support and the polyimide film, laser irradiation is often used for peeling the polyimide film from the support. In this case, the polyimide film needs to absorb the laser light, and therefore the polyimide film is required to have a cut-off wavelength longer than the wavelength of the laser light used for peeling. For laser peeling, a XeCl excimer laser with a wavelength of 308 nm is often used, and therefore the polyimide film may have a cut-off wavelength of 312 nm or more, or 330 nm or more. Meanwhile, a polyimide film having a long cut-off wavelength tends to be colored yellow, and therefore the polyimide film may have a cut-off wavelength of 390 nm or less. From the viewpoint of achieving both the transparency (low yellowness) and the processability of laser peeling, the polyimide film may have a cut-off wavelength of 320 nm or more and 390 nm or less, or 330 nm or more and 390 nm or less. The cut-off wavelength in the present description means the wavelength at which the transmittance becomes 0.1% or less as measured by an ultraviolet-visible spectrophotometer.

The polyamic acid composition and the polyimide according to the present embodiment may be used as they are in coating or a molding process for preparation of a product or a member, and can also be used as a material for a further treatment such as coating on a molded product molded into a film shape. For use in coating or a molding process, a composition containing the specific polyamic acid or the polyimide may be prepared by dissolving or dispersing the polyamic acid composition or the polyimide in an organic solvent as necessary, and further blending a photocurable component, a thermosetting component, a non-polymerizable binder resin, and another component as necessary.

On a surface of the polyimide film according to the present embodiment, various inorganic thin films may be formed such as a metal oxide thin film and a transparent electrode. The methods of forming these inorganic thin films are not particularly limited, and examples thereof include PVD methods such as a sputtering method, a vacuum vapor deposition method, and an ion plating method, and CVD methods.

In the polyimide film according to the present embodiment, the internal stress generated at the time of forming a laminate with a glass substrate is so small that the adhesion to an inorganic material during a high-temperature process can be ensured in addition to the heat resistance, the low thermal expansion, and the transparency, and therefore the polyimide film may be used in fields and products where these properties are effective. For example, the polyimide film according to the present embodiment may be used in an image display device such as a liquid crystal display device, an organic EL, or an electronic paper, a printed matter, a color filter, a flexible display, an optical film, a 3D display, a touch panel, a transparent conductive film substrate, a solar cell, or the like, or may be used as an alternative material for a portion where glass is currently used. In these uses, the polyimide film has a thickness of, for example, 1 μm or more and 200 μm or less, or 5 μm or more and 100 μm or less. The thickness of the polyimide film can be measured by using a laser hologage.

The polyamic acid composition according to the present embodiment can be suitably used in a method of producing a polyimide film, in which the polyamic acid composition is applied onto a support and imidized by heating and then the polyimide film is peeled from the support. Furthermore, the polyamic acid composition according to the present embodiment can be suitably used in a batch-type device preparation process in which the polyamic acid composition is applied onto a support and imidized by heating, an electronic element or the like is formed on the formed polyimide film, and then the polyimide film on which the electronic element or the like is formed is peeled from the support. Therefore, the present embodiment also includes a method of producing an electronic device, including a step of applying the polyamic acid composition onto a support, heating the polyamic acid composition to imidize the polyamic acid, and forming an electronic element or the like on a polyimide film formed on the support. The method of producing an electronic device may further include a step of peeling the polyimide film on which the electronic element or the like is formed from the support.

### EXAMPLES

Examples of one or more embodiments of the present invention will be described below, but the scope of the present invention is not limited to the following examples.

### <Methods of Measuring Physical Properties>

First, methods of measuring physical properties of a polyimide (polyimide film) will be described.

### [Yellowness Index (YI)]

For the polyimide film in each laminate obtained in Examples and Comparative Examples described below, the transmittance of light having a wavelength of 200 nm or more and 800 nm or less was measured using an ultraviolet visible near infrared spectrophotometer (“V-650” manufactured by JASCO Corporation), and the yellowness index (YI) of the polyimide film was calculated from the formula described in JIS K 7373-2006.

### [400 nm Transmittance]

For the polyimide film in each laminate obtained in Examples and Comparative Examples described below, the transmittance of light having a wavelength of 400 nm (400 nm transmittance) was measured using an ultraviolet visible near infrared spectrophotometer (“V-650” manufactured by JASCO Corporation).

### [Haze]

For the polyimide film peeled from each laminate obtained in Examples and Comparative Examples described below, the haze was measured with the method described in JIS K 7136-2000 using an integrating sphere haze meter (“HM-150N” manufactured by Murakami Color Research Laboratory). A polyimide film having a haze of 1.0% or less was evaluated to be “excellent in transparency”. A polyimide film having a haze of more than 1.0% was evaluated to be “not excellent in transparency”.

### [Internal Stress]

Each polyamic acid composition prepared in Examples and Comparative Examples described below was applied with a spin coater onto a glass substrate manufactured by Corning Incorporated (material: alkali-free glass, thickness: 0.7 mm, size: 100 mm×100 mm) measured in advance to determine the amount of warpage, and the resulting product was heated at 120 °C for 30 minutes in the air, and then heated at 430 °C for 30 minutes in a nitrogen atmosphere to obtain a laminate including a polyimide film having a thickness of 10 μm on the glass substrate. In order to eliminate the influence of water absorption of the polyimide film, the laminate was dried at 120 °C for 10 minutes, and then the amount of warpage of the laminate was measured in a nitrogen atmosphere at a temperature of 25 °C using a thin film stress measuring device (“FLX-2320-S” manufactured by KLA-Tencor Corporation). Then, from the amount of warpage of the glass substrate before formation of the polyimide film and the amount of warpage of the laminate, the internal stress generated between the glass substrate and the polyimide film was calculated with the Stoney equation.

[Analysis of Gas Generated from Polyimide Film]

The gas generated from the polyimide film during heating was analyzed using an analyzer in which a thermogravimetric analyzer (“STA 449 F5” manufactured by NETZSCH) and a quadrupole mass spectrometer (“JMS-Q 1500GC” manufactured by JEOL Ltd.) were combined. Hereinafter, the analysis procedure will be described.

First, the voltage of the quadrupole mass spectrometer was adjusted using octafluoronaphthalene as a standard substance so that the detection intensity of the peak at m/z=69 was 800,000. Next, each polyimide film (specifically, each polyimide film sampled from each laminate so as to have a mass of 140 mg) obtained in Examples and Comparative Examples described below was heated at a temperature rise rate of 10 °C/min from an atmospheric temperature of 60 °C to 500 °C under a helium gas flow having a flow rate of 100 mL/min using the thermogravimetric analyzer. Then, the gas generated from the polyimide during heating was analyzed with the quadrupole mass spectrometer to obtain a mass spectrum. From the obtained mass spectrum, the HF intensity ratio was calculated. When the polyimide film is heated under a helium gas flow using the analyzer, the helium gas becomes a carrier gas, and the gas generated from the polyimide film can be analyzed in real time with the quadrupole mass spectrometer.

A polyimide film having an HF intensity ratio of 3.0 or less was evaluated to be “capable of suppressing generation of hydrogen fluoride during a high-temperature process”. A polyimide film having an HF intensity ratio of more than 3.0 was evaluated to be “incapable of suppressing generation of hydrogen fluoride during a high-temperature process”.

### <Preparation of Polyimide Film>

Hereinafter, the methods of preparing a polyimide film (laminate) in Examples and Comparative Examples will be described. In the following, compounds and reagents are represented by the following abbreviations. The polyamic acid compositions for use in preparation of the polyimide films were each prepared in a nitrogen atmosphere.
NMP: N-methyl-2-pyrrolidone
a-BPDA: 2,3,3′,4′-Biphenyltetracarboxylic dianhydride
i-BPDA: 2,2′,3,3′-Biphenyltetracarboxylic dianhydride
BPAF: 9,9-Bis(3,4-dicarboxyphenyl)fluorene dianhydride
SFDA: Spiro[11H-difuro[3,4-b:3′,4′-i]xanthene-11,9′-[9H]fluorene]-1,3,7,9-tetrone
s-BPDA: 3,3′,4,4′-Biphenyltetracarboxylic dianhydride
NTCDA: 2,3,6,7-Naphthalenetetracarboxylic dianhydride
TFMOB: 2,2′-Bis(trifluoromethoxy)benzidine
TFMB: 2,2′-Bis(trifluoromethyl)benzidine
2PhI: 2-Phenylimidazole
PX-200: Resorcinol poly(di-2,6-xylyl) phosphate manufactured by DAIHACHI CHEMICAL INDUSTRY CO., LTD.
TPP: Triphenyl phosphate

### Example 1

Into a 300 mL glass separable flask equipped with a stirrer including a stainless steel stirring rod and with a nitrogen inlet tube, 56.7 g of NMP was put as an organic solvent for polymerization. Then, 4.908 g of TFMOB was put into the flask and dissolved while the flask contents were stirred. Then, 2.459 g of s-BPDA and 2.633 g of SFDA were added to the flask contents, and then the flask contents were stirred for 24 hours under an atmosphere at a temperature of 25 °C to obtain a polyamic acid composition. The obtained polyamic acid composition was applied using a spin coater onto a glass substrate (manufactured by Corning Incorporated, material: alkali-free glass, thickness: 0.7 mm, size: 100 mm×100 mm), and the resulting product was heated at 120 °C for 30 minutes in the air, and then heated at 430 °C for 30 minutes in a nitrogen atmosphere to obtain a laminate including a polyimide film having a thickness of 10 μm on the glass substrate (laminate of Example 1).

### Examples 2, 4 to 6, 9, and 12 and Comparative Examples 1 to 5

Laminates of Examples 2, 4 to 6, 9, and 12 and Comparative Examples 1 to 5 were each obtained with the same method as in Example 1, except that the used acid dianhydride, the ratio of each acid dianhydride put into the flask, the used diamine, the ratio of each diamine put into the flask, and the thickness of the polyimide film were changed as shown in Table 1. The total substance amount of acid dianhydride at the time of preparing the polyamic acid composition in each of Examples 2, 4 to 6, 9, and 12 and Comparative Examples 1 to 5 was the same as that in Example 1.

### Examples 3, 7, 8, 10, 11, and 13 to 18

Laminates of Examples 3, 7, 8, 10, 11, and 13 to 18 were each obtained with the same method as in Example 1, except that the used acid dianhydride, the ratio of each acid dianhydride put into the flask, the used diamine, and the ratio of each diamine put into the flask were changed as shown in Table 1, the flask contents were stirred for 24 hours and then an additive was added in an amount shown in Table 1 to the flask contents to obtain a polyamic acid composition, and the thickness of the polyimide film was changed as shown in Table 1. The total substance amount of acid dianhydride at the time of preparing the polyamic acid composition in each of Examples 3, 7, 8, 10, 11, and 13 to 18 was the same as that in Example 1.

For Examples 1 to 18 and Comparative Examples 1 to 5, Table 1 shows the used acid dianhydride, the ratio of each acid dianhydride put into the flask, the used diamine, the ratio of each diamine put into the flask, the kind and the amount of the additive, and the thickness of the polyimide film. In Table 1, “-” means that the relevant component was not used. In Table 1, the numerical value in the column of “Acid dianhydride” is the content (unit: mol %) of each acid dianhydride with respect to the total amount (100 mol %) of acid dianhydrides used. In Table 1, the numerical value in the column of “Diamine” is the content (unit: mol %) of each diamine with respect to the total amount (100 mol %) of acid dianhydrides used. In Table 1, the numerical value in the column of “Amount” of “Additive” is the amount (unit: part by weight) of the additive used with respect to 100 parts by weight of the polyamic acid. In each of Examples 1 to 18 and Comparative Examples 1 to 5, the molar fraction of each residue in the polyamic acid in the prepared polyamic acid composition was equal to the molar fraction of each monomer (each monomer corresponding to each residue) used in synthesis of the polyamic acid.

For Examples 1 to 18 and Comparative Examples 1 to 5, Table 2 shows the internal stress, the 400 nm transmittance, the YI, the haze, and the HF intensity ratio. In Table 2, “-” means that measurement was not performed.

TABLE 1

| | | | | | | | | | Additive | | Thickness |
|---|---|---|---|---|---|---|---|---|---|---|---|
| | | | | | | | | | | Amount | of |
| | Acid dianhydride [mol %] | | | | | | Diamine [mol %] | | | [parts by | polyimide |
| | a-BPDA | i-BPDA | BPAF | SFDA | s-BPDA | NTCDA | TFMOB | TFMB | Kind | weight] | film [μm] |
| Example 1 | — | — | — | 40 | 60 | — | 100 | — | — | — | 10 |
| Example 2 | — | — | — | 35 | 50 | 15 | 101 | — | — | — | 10 |
| Example 3 | — | — | 15 | 65 | — | 20 | 101 | — | 2PhI | 1 | 10 |
| Example 4 | — | — | — | 70 | — | 30 | 101 | — | — | — | 12 |
| Example 5 | — | — | 5 | 61 | — | 34 | 101 | — | — | — | 12 |
| Example 6 | — | — | — | 60 | — | 40 | 101 | — | — | — | 11 |
| Example 7 | — | — | — | 34 | 26 | 40 | 101 | — | 2PhI | 1 | 10 |
| Example 8 | — | — | 15 | 35 | — | 50 | 101 | — | 2PhI | 1 | 10 |
| Example 9 | — | — | — | 50 | — | 50 | 101 | — | — | — | 12 |
| Example 10 | — | — | — | 40 | — | 60 | 100 | — | 2PhI | 1 | 10 |
| Example 11 | — | — | 100 | — | — | — | 100 | — | 2PhI | 1 | 13 |
| Example 12 | — | — | — | 100 | — | — | 100 | — | — | — | 11 |
| Example 13 | 30 | — | — | — | 70 | — | 100 | — | 2PhI | 1 | 10 |
| Example 14 | — | 30 | — | — | 70 | — | 100 | — | 2PhI | 1 | 14 |
| Example 15 | — | — | 30 | — | 70 | — | 100 | — | 2PhI | 1 | 11 |
| Example 16 | — | — | — | 80 | 20 | — | 100 | — | 2PhI | 1 | 11 |
| Example 17 | — | — | — | 34 | 26 | 40 | 101 | — | PX-200 | 1 | 10 |
| Example 18 | — | — | — | 34 | 26 | 40 | 101 | — | TPP | 1 | 10 |
| Comparative | — | — | — | — | 100 | — | — | 100 | — | — | 10 |
| Example 1 | | | | | | | | | | | |
| Comparative | — | — | — | — | 100 | — | 100 | — | — | — | 10 |
| Example 2 | | | | | | | | | | | |
| Comparative | — | — | 100 | — | — | — | — | 100 | — | — | 13 |
| Example 3 | | | | | | | | | | | |
| Comparative | — | — | — | 100 | — | — | — | 100 | — | — | 11 |
| Example 4 | | | | | | | | | | | |
| Comparative | — | — | — | — | — | 100 | — | 100 | — | — | 7 |
| Example 5 | | | | | | | | | | | |

TABLE 2

| | Internal | 400 nm | | | HF |
|---|---|---|---|---|---|
| | stress | Transmit- | | Haze | intensity |
| | [MPa] | tance [%] | YI | [%] | ratio |
| Example 1 | 32 | 47 | 6 | 0.4 | 2.2 |
| Example 2 | 34 | 44 | 8 | 0.1 | 2.9 |
| Example 3 | 43 | 60 | 6 | 0.3 | 2.7 |
| Example 4 | 40 | 47 | 9 | 0.2 | 2.3 |
| Example 5 | 33 | 47 | 9 | 0.4 | 3.0 |
| Example 6 | 27 | 41 | 11 | 0.5 | 1.9 |
| Example 7 | 6 | 32 | 9 | 0.5 | 2.0 |
| Example 8 | 29 | 37 | 9 | 0.3 | 2.9 |
| Example 9 | 17 | 36 | 10 | 0.6 | 2.5 |
| Example 10 | −2 | 31 | 10 | 0.5 | 2.5 |
| Example 11 | — | 65 | 6 | 0.2 | 2.9 |
| Example 12 | 47 | 63 | 7 | 0.0 | 2.1 |
| Example 13 | — | 38 | 7 | 0.3 | 2.2 |
| Example 14 | — | 28 | 11 | 0.3 | 2.2 |
| Example 15 | — | 39 | 9 | 0.2 | 3.0 |
| Example 16 | — | 61 | 6 | 0.0 | 2.9 |
| Example 17 | 13 | 32 | 8 | 0.5 | 1.1 |
| Example 18 | 11 | 32 | 8 | 0.5 | 2.1 |
| Comparative Example 1 | 28 | 37 | 18 | 2.3 | 3.3 |
| Comparative Example 2 | 28 | 20 | 20 | 2.6 | 1.0 |
| Comparative Example 3 | 47 | 72 | 6 | 0.1 | 7.5 |
| Comparative Example 4 | 49 | 63 | 8 | 0.4 | 6.1 |
| Comparative Example 5 | — | 42 | 11 | 1.1 | 18.7 |

As shown in Table 1, the polyamic acid in the polyamic acid composition prepared in each of Examples 1 to 18 had a specific diamine residue (TFMOB residue). As shown in Table 1, the polyamic acid in the polyamic acid composition prepared in each of Examples 1 to 18 had a specific acid dianhydride residue.

As shown in Table 2, in Examples 1 to 18, the HF intensity ratio was 3.0 or less. Thus, the polyimide film obtained in each of Examples 1 to 18 was capable of suppressing generation of hydrogen fluoride during a high-temperature process. As shown in Table 2, in Examples 1 to 18, the haze was 1.0% or less. Thus, the polyimide film obtained in each of Examples 1 to 18 was excellent in transparency.

As shown in Table 1, the polyamic acid in the polyamic acid composition prepared in each of Comparative Examples 1 and 3 to 5 did not have a specific diamine residue. As shown in Table 1, the polyamic acid in the polyamic acid composition prepared in each of Comparative Examples 1, 2, and 5 did not have a specific acid dianhydride residue.

As shown in Table 2, in Comparative Examples 1 and 3 to 5, the HF intensity ratio was more than 3.0. Thus, the polyimide film obtained in each of Comparative Examples 1 and 3 to 5 was incapable of suppressing generation of hydrogen fluoride during a high-temperature process. As shown in Table 2, in Comparative Examples 1, 2, and 5, the haze was more than 1.0%. Thus, the polyimide film obtained in each of Comparative Examples 1, 2, and 5 was not excellent in transparency.

From the above results, it has been shown that the polyimide obtained from the polyamic acid composition according to one or more embodiments of the present invention is excellent in transparency and capable of suppressing generation of hydrogen fluoride during a high-temperature process.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A polyamic acid comprising a tetracarboxylic dianhydride residue and a diamine residue, wherein:
the diamine residue comprises a divalent organic group represented by General Formula (1), and
the tetracarboxylic dianhydride residue comprises one or more selected from the group consisting of a tetravalent organic group represented by Chemical Formula (2), a tetravalent organic group represented by Chemical Formula (3), a tetravalent organic group represented by Chemical Formula (4), a tetravalent organic group represented by Chemical Formula (5), a tetravalent organic group represented by Chemical Formula (6), a tetravalent organic group represented by Chemical Formula (7), a tetravalent organic group represented by Chemical Formula (8), a tetravalent organic group represented by Chemical Formula (9), and a tetravalent organic group represented by Chemical Formula (10): 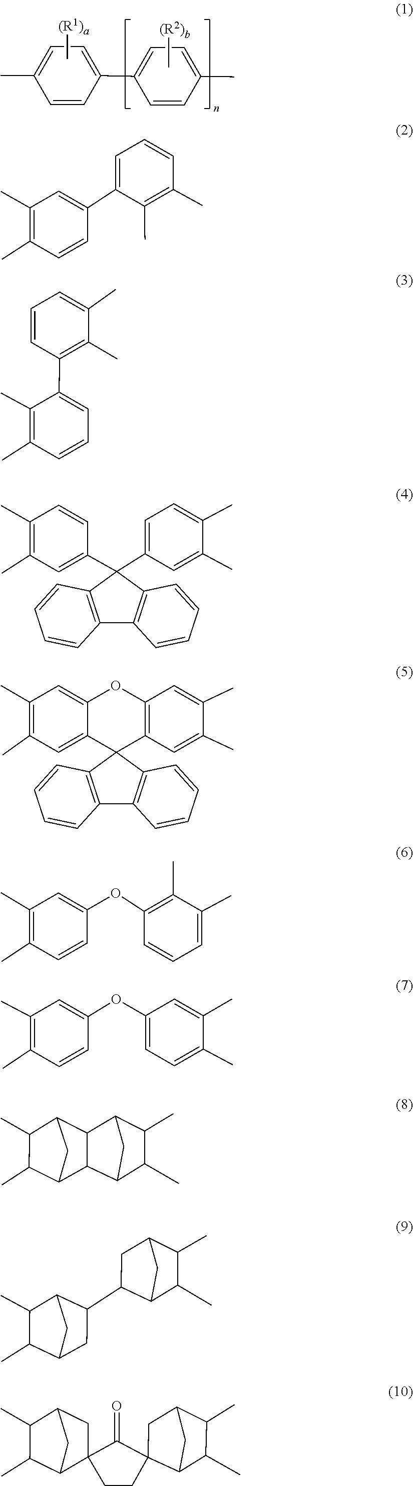
wherein R¹ and R² each independently represent a trifluoromethoxy group, a pentafluoroethoxy group, or a heptafluoropropoxy group, a represents an integer of 1 or more and 4 or less, b represents an integer of 0 or more and 4 or less, a plurality of R¹s are the same or different when a represents an integer of 2 or more and 4 or less, a plurality of R²s are the same or different when b represents an integer of 2 or more and 4 or less, and n represents an integer of 0 or more and 3 or less.

2. The polyamic acid according to claim 1, wherein the tetracarboxylic dianhydride residue further includes one or more selected from the group consisting of a tetravalent organic group represented by Chemical Formula (11), a tetravalent organic group represented by Chemical Formula (12), and a tetravalent organic group represented by Chemical Formula (13):

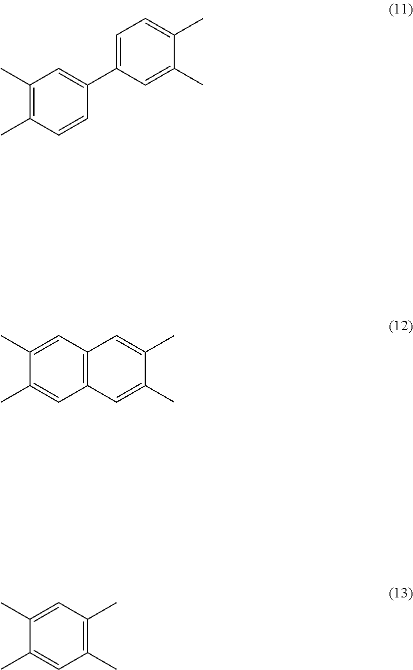

3. A polyamic acid composition comprising the polyamic acid according to claim 1 and an organic solvent.

4. The polyamic acid composition according to claim 3, further comprising one or more compounds selected from the group consisting of tertiary amines, phosphorus-containing compounds, and phenolic compounds.

5. The polyamic acid composition according to claim 4, wherein an amount of the one or more compounds is 0.001 parts by weight or more and 20 parts by weight or less with respect to 100 parts by weight of the polyamic acid.

6. A polyimide being an imidized product of the polyamic acid according to claim 1.

7. The polyimide according to claim 6, wherein a value obtained by dividing a detection intensity of a peak at m/z=20 at an atmospheric temperature of 450 °C by a detection intensity of a peak at m/z=20 at an atmospheric temperature of 100 °C is 3.0 or less,
wherein the detection intensities are obtained from a mass spectrum by heating the polyimide at a temperature rise rate of 10 °C/min from an atmospheric temperature of 60 °C to 500 °C under a helium gas flow and analyzing a gas generated from the polyimide with a quadrupole mass spectrometer.

8. A polyimide film comprising the polyimide according to claim 6.

9. The polyimide film according to claim 8, having a transmittance of light having a wavelength of 400 nm of 30% or more.

10. The polyimide film according to claim 8, having a haze of 1.0% or less.

11. The polyimide film according to claim 8, having a yellowness index of 15 or less.

12. A laminate comprising a support and the polyimide film according to claim 8.

13. A method of producing a laminate comprising a support and a polyimide film, the method comprising:
applying the polyamic acid composition according to claim 3 onto a support to form a coating film containing the polyamic acid, and
heating the coating film to imidize the polyamic acid.

14. An electronic device comprising the polyimide film according to claim 8 and an electronic element disposed on the polyimide film.
